(19) United States
(12) Patent Application Publication
(10) Pub. No.: US 2022/0105426 A1
(43) Pub. Date: Apr. 7, 2022

(54) Interactive Amusement Ride

(71) Applicant: Mark Williford, Seymour, TN (US)

(72) Inventor: Mark Williford, Seymour, TN (US)

(21) Appl. No.: 17/449,937

(22) Filed: Oct. 4, 2021

Related U.S. Application Data
(60) Provisional application No. 63/086,703, filed on Oct. 2, 2020.

(51) Int. Cl. A63F 13/219; A63F 13/837; A63G 31/02; A63G 33/00; A63G 7/00

(52) U.S. Cl. CPC A63F 13/219; A63F 13/837; A63G 7/00; A63G 33/00; A63G 31/02

(57) ABSTRACT

An interactive amusement ride includes: a car having at least one control element for controlling movement of the car; a light gun located on the car, the light gun in electronic communication with a control computer of the amusement ride; a track shaped to support the car thereon, the track having an interactive area comprising a portion of the track where a passenger does not control movement of the car with the at least one control element and a ride area comprising a portion of the track; one or more targets located along the interactive area of the track. The one or more targets detect a light emission from the light gun when the light gun is oriented towards the one or more targets.

### CROSS-REFERENCE TO RELATED APPLICATION(S)

This applications claims priority to and is a non-provisional of U.S. Provisional Patent Application Ser. No. 63/086,703 for an “Interactive Amusement Ride” filed on Oct. 2, 2020, the contents of which are incorporated herein by reference in its entirety.

### FIELD

This disclosure relates to the field of amusement rides. More particularly, this disclosure relates to an interactive amusement ride allowing passengers to at least partially control motion of the ride while interacting with the ride.

### BACKGROUND

Various amusement rides exist that allow passengers provide a thrilling ride for passengers. Although entertaining, some interactivity may be desired during the ride to further engage passengers and provide entertainment to the passengers on the ride.

Although a variety of amusement rides have been constructed, many do not include any interactivity that would allow the passengers to further be entertained during the ride. For example, many existing amusement rides solely entertain the passenger by way of movement of the ride, such as by providing high speed turns. Other types of amusement rides exist that may allow the passenger to control a speed of the passenger on the ride. Mountain coaster-type rides may provide a brake for a passenger to activate such that the passenger may allow a car traveling on a track to speed up or slow down depending on engagement of the brake. Such rides typically do not provide any other type of interactivity for the passenger.

What is needed, therefore, is an amusement ride that both allows the passenger to control at least some dynamics of the ride while also allowing the passenger to actively interact with the ride.

### SUMMARY

The above and other needs are met by an amusement ride that both allows the passenger to control at least some dynamics of the ride while also allowing the passenger to actively interact with the ride. In a first aspect, an interactive amusement ride includes: a car having at least one control element for controlling movement of the car; a light gun located on the car, the light gun in electronic communication with a control computer of the amusement ride; a track shaped to support the car thereon, the track having an interactive area comprising a portion of the track where a passenger does not control movement of the car with the at least one control element and a ride area comprising a portion of the track one or more targets located along the interactive area of the track, wherein the one or more targets detect a light emission from the light gun when the light gun is oriented towards the one or more targets.

In one embodiment, the control element is a brake for controlling a speed of the car along the ride area.

In another embodiment, the light gun is in wireless communication with the control computer of the amusement ride. In yet another embodiment, operation of the light gun within the ride area is restricted such that the light gun is not operable within the ride area.

In one embodiment, the interactive area is an area where the control element does not affect movement of the car along the track. In another embodiment, the interactive area is an inclined portion of a coaster ride. In yet another embodiment, the ride area is a declined portion of a coaster ride and wherein the control element controls a speed of the car along the track.

In a second aspect, an interactive amusement ride includes: a car having at least one control element for controlling movement of the car; a light gun located on the car, the light gun in electronic communication with a control computer of the amusement ride; a track shaped to support the car thereon, the track having an interactive area comprising an inclined portion of a coaster ride where a passenger does not control movement of the car with the at least one control element and a ride area comprising a decline portion of the track on a coaster ride; one or more targets located along the interactive area of the track, wherein the one or more targets detect a light emission from the light gun when the light gun is oriented towards the one or more targets.

In one embodiment, operation of the light gun within the ride area is restricted such that the light gun is not operable within the ride area.

In a third aspect, an interactive amusement ride includes: a car having at least one control element for controlling braking of the car; a light gun located on the car, the light gun in electronic communication with a control computer of the amusement ride; a track shaped to support the car thereon, the track having an interactive area comprising a portion of the track where a passenger does not control braking of the car with the at least one control element and a ride area comprising a portion of the track one or more targets located along the interactive area of the track, wherein the one or more targets detect a light emission from the light gun when the light gun is oriented towards the one or more targets.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a schematic view of an amusement ride according to one embodiment of the present disclosure;

FIG. 2 shows a view along a track of an amusement ride including a plurality of targets according to one embodiment of the present disclosure;

FIG. 3 shows a target having a sensor according to one embodiment of the present disclosure;

FIG. 4 shows a car of an amusement ride having a light gun according to one embodiment of the present disclosure; and

FIG. 5 shows a schematic view of an amusement ride according to one embodiment of the present disclosure.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

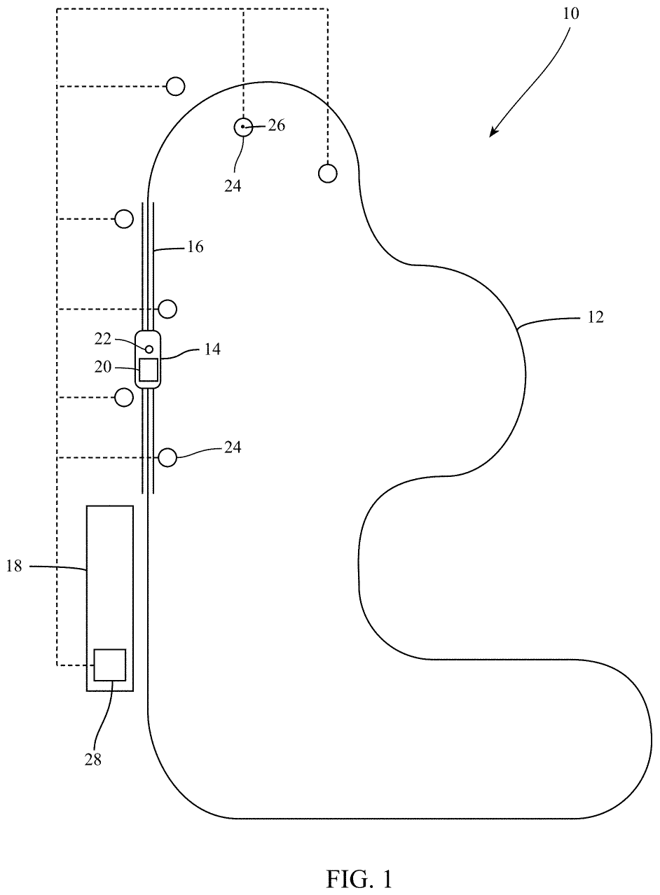

FIG. 1 shows a schematic view of an amusement ride 10 that allows for a passenger to actively engage with the ride while also controlling at least one aspect of the ride. The amusement ride 10 enables the passenger to control at least one aspect of the ride, such as a speed of a car in which the passenger is riding, while also allowing the passenger to interact with the ride. Exemplary embodiments of interacting with the ride may include shooting at electronic targets located around the ride during at least portions of the ride, thereby further allowing the passenger to engage with the ride and to be entertained throughout all portions of the amusement ride 10.

The amusement ride 10 includes a track 12. The track 12 may be, for example, a pair of rails or a single rail on which a car 14 rides. The track 12 may include an inclined portion 16 during which the car 14 is pulled uphill towards an elevated portion along the track 12 before moving along the remainder of the track 12 by gravity. The amusement ride 10 may further include a platform 18 where passengers embark and disembark from the car 14.

The car 14 may include a seat 20 for a passenger to sit on the car 14. The car 14 may be, for example, a single passenger car 14 that travels along the track 12. The car 14 may include a passenger control 22 located on the car. The passenger control 22 allows the passenger to control at least one aspect of the car 14 as it travels on the track 12. For example, the passenger control 22 may be a brake that allows the passenger to slow down the car 14 on the track 12 when the passenger engages the brake.

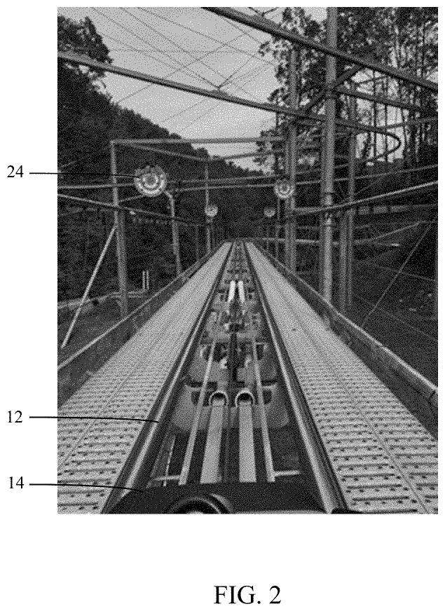

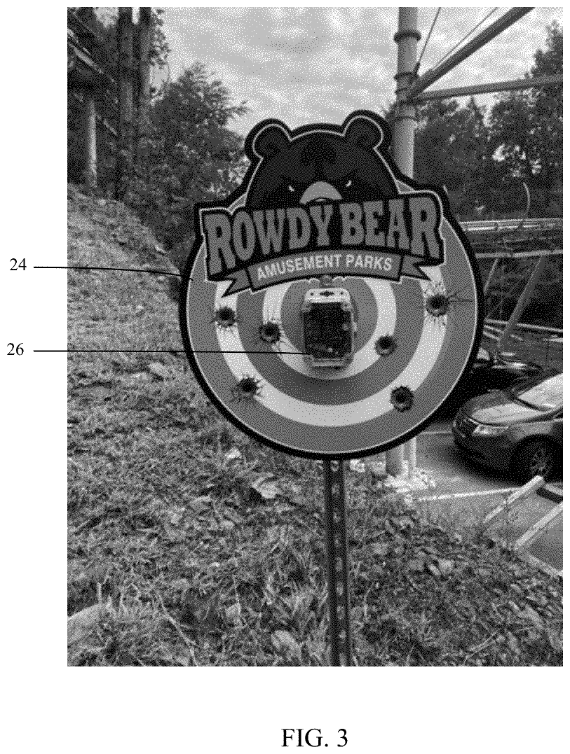

With further reference to FIG. 1, the amusement ride 10 further includes a plurality of targets 24 located proximate to at least a portion of the track 12. An exemplary embodiment of the targets is shown in FIGS. 2 and 3. The target 24 includes a sensor 26 located on the target 24. The sensor 26 may be, for example, a light sensor (such as a laser or infrared sensor). The sensor 26 of the target 24 is in electronic communication with a control computer 28. In one embodiment, the sensor 26 of the target 24 may be in electronic communication with the computer 28 such that when the sensor 26 on the target 24 detects light, the control computer 28 receives a signal from the target 24.

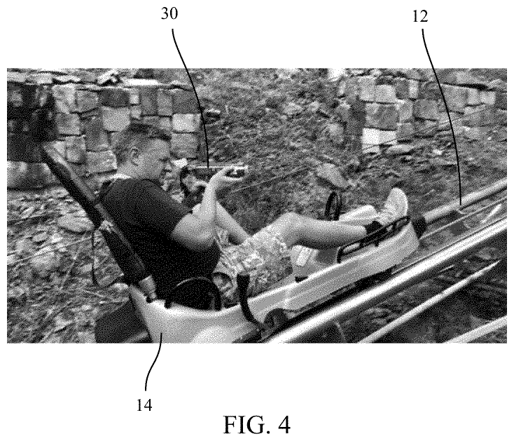

Referring to FIG. 4, the car 14 may include a light gun 30 located on the car 14 and operable by a passenger of the car 14. The light gun 30 is preferably configured to emit a light, such as a laser or infrared light from the gun that is detectable by the sensor 26 on the target 24. The light gun 30 may be powered by a battery or other power source located on the car 14. The light gun 30 may be in electronic communication with the computer 28 and associated with a particular car 14 such that when the light gun 30 is used to shoot at one of the targets 24, the computer 28 may determine whether the light gun 30 has shot the target 24. A score of each passenger may be tracked using the computer 28 by determining a number of times that the passenger hits the targets 24 with the light gun 30.

The amusement ride 10 may be configured such that the targets 24 are located in desired areas proximate to the track 12. For example, in one embodiment the targets 24 are located in areas where the passenger does not desire to activate the passenger control 22 of the car. For example, the targets 24 may be located along portions of the track 12 where the car is moving slowly, such as on an incline or on slow portions of the ride. On other portions where the car 14 may move faster along the track 12, there may be no targets 24 proximate to the track such that the passenger uses the passenger control 22 to control movement of the car 14 on those portions of the track 12.

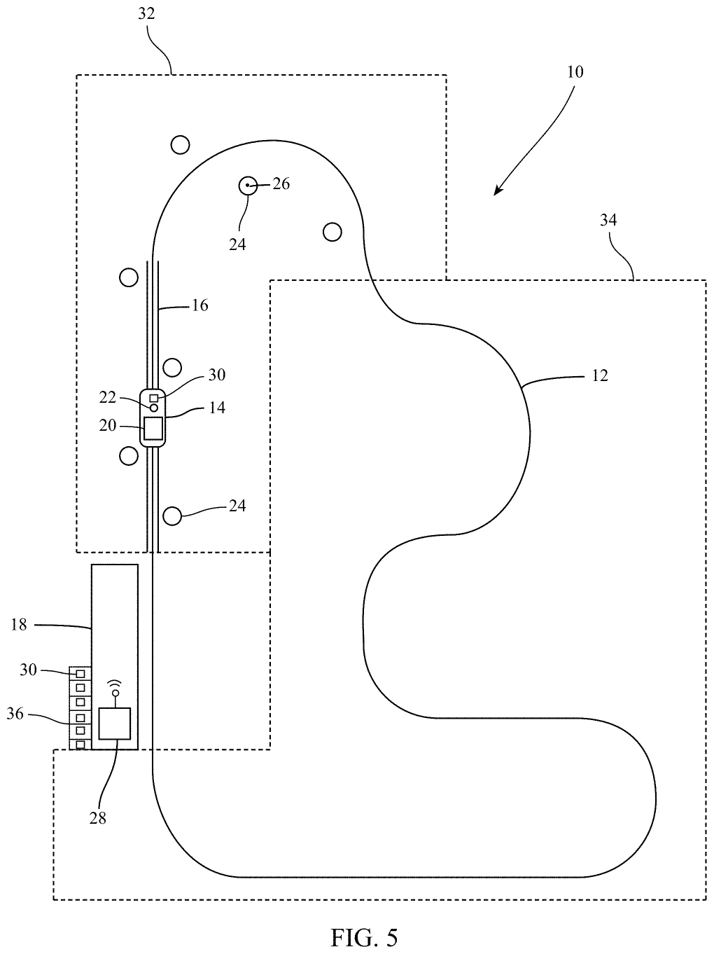

Referring to FIG. 5, the control computer 28 may be in electronic communication with the light gun 30 wirelessly. The targets 24 may be static targets and may be configured such that when the light gun 30 engages the targets 24, a light emitted from the light gun 30 is reflected from the targets 24 back to the light gun 30. The light gun 30 may then communicate wirelessly with the control computer 28 to indicate that the target 24 was hit by the light gun 30.

Further referring to FIG. 5, the amusement ride 10 may include an interactive area 32. The interactive area 32 may correspond to a portion of the track 12 where the one or more targets 24 are located for engagement with the light gun 30 by a passenger on the amusement ride 10. The interactive area 32 may correspond, for example, to an incline or slower portion of the track 12 where control of the car 14 by the passenger is not required. The interactive area 32 may include the inclined portion 16 of the amusement ride 10 where the car 14 is being pulled uphill. The amusement ride 10 may further include a ride area 34. The ride area 34 may correspond to a portion of the track 12 where a passenger controls operation of the car 16 with the passenger control 22. The ride area 34 may not include any of the targets 24. The ride area 34 may further exclude operation of the light gun 30 within the ride area 34. The ride area 34 may be declined such that the car 14 travels at a higher speed along the ride area 34 than the interactive area 34 and such that the passenger may engage the passenger control 22 to control travel of the car 14 along the track 12. The amusement ride 10 may further include a light gun area 36, such as located on the platform 18. The light gun area 36 may include one or more chargers for charging the light gun 30 prior to use on the amusement ride by the passenger.

Embodiments of the amusement ride 10 described herein advantageously enable a passenger to be entertained throughout the duration of the ride. The passenger may use the gun 30 to engage targets 24 along the track 12 during portions of the ride that may be less thrilling. The passenger may otherwise be entertained along other portions of the track 12 that are more thrilling. Further, embodiments of the amusement ride 10 provide multiple means of allowing the passenger to engage with the ride by allowing the passenger to both control movement of the car 14 and to interact with targets 24 around the track 12. Although reference herein is made to a mountain coaster-type ride, it is also understood that embodiments of the amusement ride described herein may be suitable for various other types of rides, such as chairlifts and other coaster-types of rides.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. An interactive amusement ride comprising:
a car having at least one control element for controlling movement of the car;
a light gun located on the car, the light gun in electronic communication with a control computer of the amusement ride;
a track shaped to support the car thereon, the track having
an interactive area comprising a portion of the track where a passenger does not control movement of the car with the at least one control element and
a ride area comprising a portion of the track
one or more targets located along the interactive area of the track, wherein the one or more targets detect a light emission from the light gun when the light gun is oriented towards the one or more targets.

2. The interactive amusement ride of claim 1, wherein the control element comprises a brake for controlling a speed of the car along the ride area.

3. The interactive amusement ride of claim 1, wherein the light gun is in wireless communication with the control computer of the amusement ride.

4. The interactive amusement ride of claim 1, wherein operation of the light gun within the ride area is restricted such that the light gun is not operable within the ride area.

5. The interactive amusement ride of claim 1, wherein the interactive area comprises an area where the control element does not affect movement of the car along the track.

6. The interactive amusement ride of claim 5, wherein the interactive area comprises an inclined portion of a coaster ride.

7. The interactive amusement ride of claim 6, wherein the ride area comprises a declined portion of a coaster ride and wherein the control element controls a speed of the car along the track.

8. An interactive amusement ride comprising:
a car having at least one control element for controlling movement of the car;
a light gun located on the car, the light gun in electronic communication with a control computer of the amusement ride;
a track shaped to support the car thereon, the track having
an interactive area comprising an inclined portion of a coaster ride where a passenger does not control movement of the car with the at least one control element and
a ride area comprising a decline portion of the track on a coaster ride;
one or more targets located along the interactive area of the track, wherein the one or more targets detect a light emission from the light gun when the light gun is oriented towards the one or more targets.

9. The interactive amusement ride of claim 1, wherein operation of the light gun within the ride area is restricted such that the light gun is not operable within the ride area.

10. An interactive amusement ride comprising:
a car having at least one control element for controlling braking of the car;
a light gun located on the car, the light gun in electronic communication with a control computer of the amusement ride;
a track shaped to support the car thereon, the track having
an interactive area comprising a portion of the track where a passenger does not control braking of the car with the at least one control element and
a ride area comprising a portion of the track
one or more targets located along the interactive area of the track, wherein the one or more targets detect a light emission from the light gun when the light gun is oriented towards the one or more targets.
